(19) United States
(12) Patent Application Publication
(10) Pub. No.: US 2010/0307308 A1
(43) Pub. Date: Dec. 9, 2010

(54) BLADE ENCLOSURE FOR A TABLE SAW

(76) Inventor: DAVID J. BUTLER, Cotuit, MA (US)

Correspondence Address: Oliver Intellectual Property LLC, P.O. Box 1670, Cotuit, MA, 02635, US

(21) Appl. No.: 12/481,542

(22) Filed: Jun. 9, 2009

(51) Int. Cl. B27B 5/29; B23D 45/06; B27G 19/02; B26D 7/18

(52) U.S. Cl. 83/100; 83/478; 83/477.2

(57) ABSTRACT

A below-table blade enclosure for a table saw protects the health and safety of the person operating the saw, by enclosing the saw blade, and thereby protecting the operator from exposure to hazardous and potentially carcinogenic saw dust. The blade enclosure contains and collects the saw dust, which is removed from the blade enclosure by an external dust collecting system, for example via a vacuum hose.

### CROSS-REFERENCE TO RELATED APPLICATION(S)

This application relates to subject-matter more fully explained in my co-pending application Ser. No. 12/______, entitled HEALTH AND SAFETY SYSTEM FOR A TABLE SAW (Attorney Docket 873-013-101), filed the same day as the present application, the disclosure of which is hereby incorporated by reference.

### FIELD OF THE INVENTION

The present invention relates generally to systems for power saws, providing improved health and safety during operation.

### BACKGROUND AND SUMMARY OF THE INVENTION

Table saws are power tools used to cut work pieces of wood, plastic and other materials. Such saws are among the most widely used power tools in woodworking and materials processing shops, carpentry and building work sites. Four general classes of table saws are in common use including bench top table saws, contractor table saws, cabinet table saws and hybrid table saws.

A table saw includes a flat surface, or table, with a circular saw blade extending vertically up through a slot in the table. The saw blade is mounted on an arbor which is driven by an electric motor (either directly, by belt, or by gears).

The saw operator slides a workpiece on the table against and past the blade while the circular blade revolves at a high rate of speed (typically about 4,000 rpm) and cuts through the workpiece.
The thickness of the workpiece that can be sawed completely through, or the depth of the cut into the workpiece, is controlled by moving a saw motor trunnion or carriage, holding the motor, saw arbor and saw blade, up or down, relative to the saw table top. The higher the blade protrudes above the table, the deeper the cut that is made in the workpiece. Commonly, the cut into the workpiece is made perpendicular to the saw table, but most table saws also can be adjusted to make cuts at angle of up to 45 degrees from the perpendicular. Such angle or bevel cuts are made by rotating the saw motor carriage from the perpendicular such that the angle of the motor, saw motor, motor arbor and blade are adjusted to provide the desired cutting angle. Table saws are generally designed to allow rotation of the carriage, motor, arbor and blade either to the left or to the right (but not both).

Table saws typically are provided with various pieces of auxiliary equipment including a rip fence to guide a work piece make rip cuts, that is to cut work pieces generally with the grain, and a miter gauge to cut work pieces perpendicular to or generally at an angle to the grain. A splitter, a vertical projection located behind the saw blade, typically either a pin or a fin shaped piece of metal, is also typically provided as a standard or optional attachment for table saws. The splitter is typically slightly narrower in width than the blade and is aligned directly in line with the blade kerf. Saws also typically are provided with an anti-kickback device that attaches to the splitter, as well as a hinged blade cover also attached to the splitter. Saws usually have an easily replaceable insert around the blade in the table top. This allows the use of special-purpose cutters and inserts as may be required for various cutting operations.

All species of saw dust have recently been classified as carcinogenic and the finer particles are considered the most harmful. Fine saw dust, such as that generated by a table saw, has been determined to be a human carcinogen and is believed to be implicated in many other respiratory ailments as well. The carcinogenicity of saw dust has been recognized by, among others, the American Conference of Government and Industrial Hygienists (ACGIH), the National Institute of Occupational Safety and Health (NIOSH) and the International Agency for Research on Cancer (IARC). Chronic exposure to saw dust has been implicated as a cause of fibrosis, emphysema, bronchitis, asthma, respiratory allergies and dermatitis. Additionally, substantial research also indicates that many of the chemicals including various glues, adhesives and preservatives used in processed wood products are highly toxic when inhaled as a component of saw dust. Recent research suggests that chronic exposure to saw dust may prove to be an even greater danger to saw operators than the perhaps more immediately obvious risk of serious trauma injury.

Partial blade enclosures intended for collection of saw dust expelled below the table surface are within the known prior art such as U.S. Pat. No. 6,925,919 issued to LIAO et al., U.S. Pat. No. 4,255,995 issued to J. FRANKLIN CONNOR, U.S. Pat. No. 4,063,478 issued to HANS STUY, and U.S. Pat. No. 4,721,023 issued to BARTLETT et. al. These and similar prior art below-table enclosures intended for dust containment and extraction suffer from shortcomings related to inadequate seal thereby allowing significant amounts of sawdust to escape the enclosure where the seals are inadequate, particularly around the rotating saw arbor and the top of the enclosure at the table insert. Since most of dust generated normally is ejected from the saw below the table it is important to maintain adequate sealing to insure maximum effectiveness of the dust containment and extraction device.

The most common and oldest prior-art dust collection method for the cabinet type or hybrid table saw allows the sawdust to simply accumulate inside the table saw base and extract it from the base using ducting to a powerful central dust collector system. More recent prior-art has introduced various designs for attaching cloth bags under the base to capture saw dust. Both of these methods fall far short of their intended goal and provide inadequate capture of dust considering the several recently discovered health hazards associated with saw dust exposure. The present invention more effectively captures and extracts saw dust from very close to the saw blade or cutter head and thus protects the saw operator from inhaling said dust. Many woodworkers as well as industrial safety officials have recently come to view, as imperative, increased control and removal of saw dust as close to the source of generation as possible, thereby minimizing environmental exposure of saw operators to these hazards. Although the problem of saw dust control has long been known, it is widely recognized that prior art dust removal efforts have failed to adequately solve this problem. Thus, there exists a need for a table saw with improved dust containment and collection system that significantly reduces exposure of table saw operators to the long term risks of exposure to carcinogenic saw dust. The below-table blade enclosure or guard of the present invention provides a significantly improved dust containment and collection enclosure that may be retrofitted to many existing table saws and, alternatively, may be incorporated into many new table saw designs.

### BRIEF DESCRIPTION OF THE DRAWINGS

FIG. 1 is a perspective view of a blade enclosure for saw dust control in accordance with one embodiment of the present invention.

FIG. 2 is a perspective view of a mounting bracket for a blade enclosure unit for a table saw in accordance with one embodiment of the present invention.

FIG. 3 is a front view of a blade enclosure for saw dust control in accordance with one embodiment of the present invention.

FIG. 4 is a rear view of a blade enclosure for saw dust control in accordance with one embodiment of the present invention.

FIG. 5 is a detailed side elevation, in a partially exploded view, of a preferred embodiment of a blade enclosure, for a table saw in accordance with the present invention.

FIG. 6 is a perspective view of a secondary insert gasket for use with a blade enclosure for a table saw in accordance with one embodiment of the present invention.

FIG. 7 is a perspective view of a secondary insert gasket, showing the position of the saw blade, for use with a blade enclosure for a table saw in accordance with one embodiment of the present invention.

FIG. 8 is a detailed top elevation, in a partially exploded view, of a preferred embodiment of a secondary insert gasket, in accordance with the present invention; AND

FIG. 9 is a perspective view of a connection to a dust collection and containment system for a table saw blade enclosure in accordance with one embodiment of the present invention.

### DETAILED DESCRIPTION OF THE INVENTION

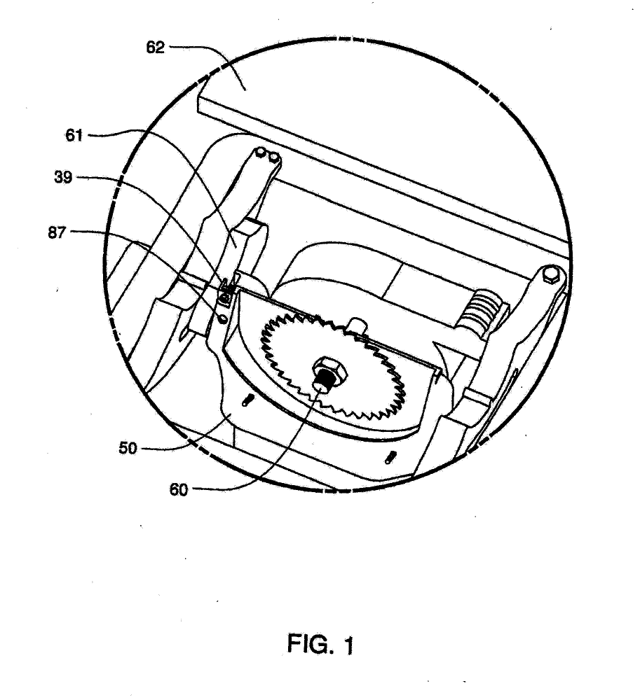

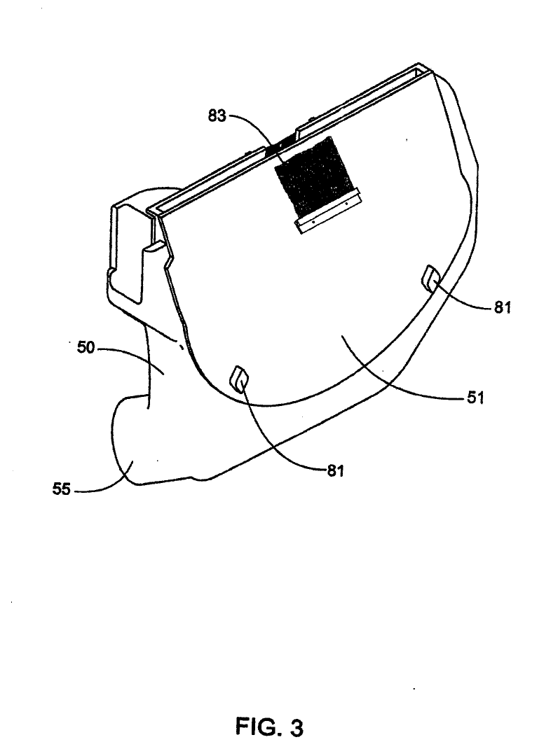

An exemplary embodiment of a blade enclosure for dust collection and containment in accordance with the present invention is illustrated schematically in FIGS. 1 and 3. The table saw to which such blade enclosure is adapted may be any type, model or configuration of table saw suitable for cutting wood, plastic or other suitable material that incorporates one or more of the various aspects of the present invention. The present invention includes complete saws as well as systems, parts, pieces or kits of parts which may be mounted on existing table saws to adapt or retrofit them in accordance with one or more of the various aspects of the present invention.

One aspect of the present invention is a blade enclosure for saw dust containment and collection, as shown in FIGS. 1 through 5, for a table saw which may be used with a dust containment and collection system for a table saw. Blade enclosures according to the present invention contribute to safe saw operation, not only by containing and collecting hazardous saw dust but also by preventing exposure of the saw operator to the handling of said hazardous saw dust. Blade enclosures of the present invention are mounted below the saw table 62 (FIG. 1), generally on the tiltable portion of the saw and motor frame carriage 61, such that blade enclosure surrounds the blade, except at the upper edge of the saw blade where the blade passes vertically through the saw table 62 in order to cut the workpiece.

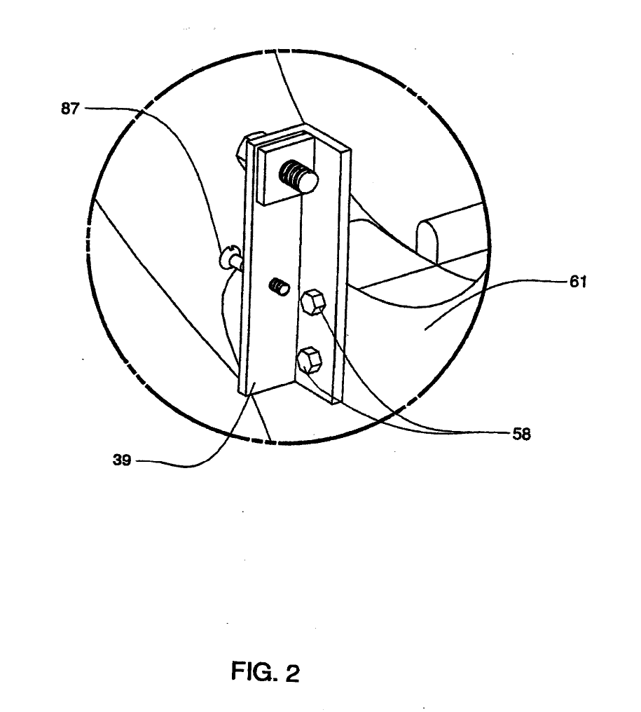

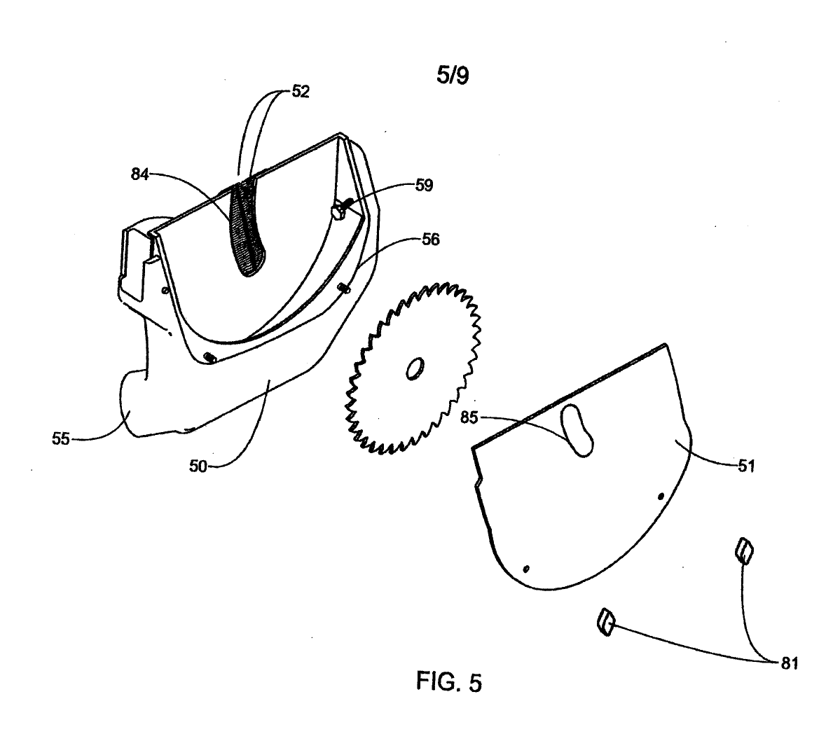

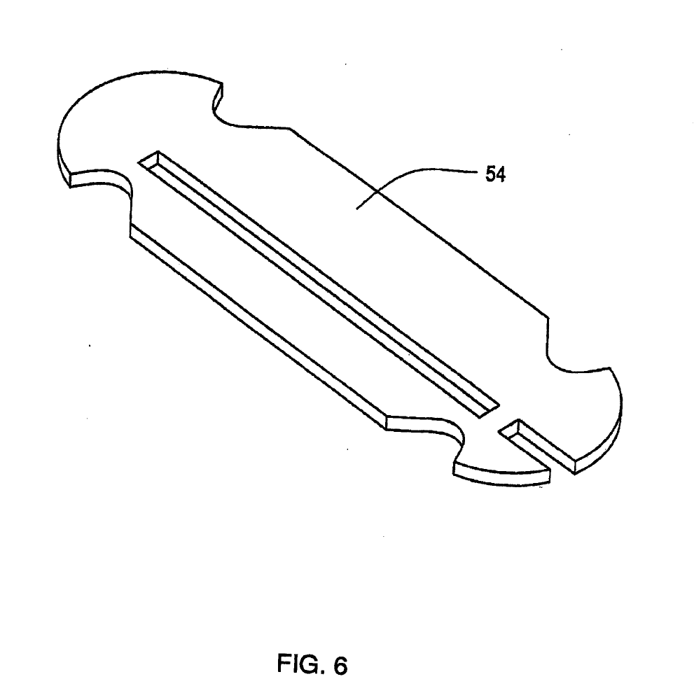

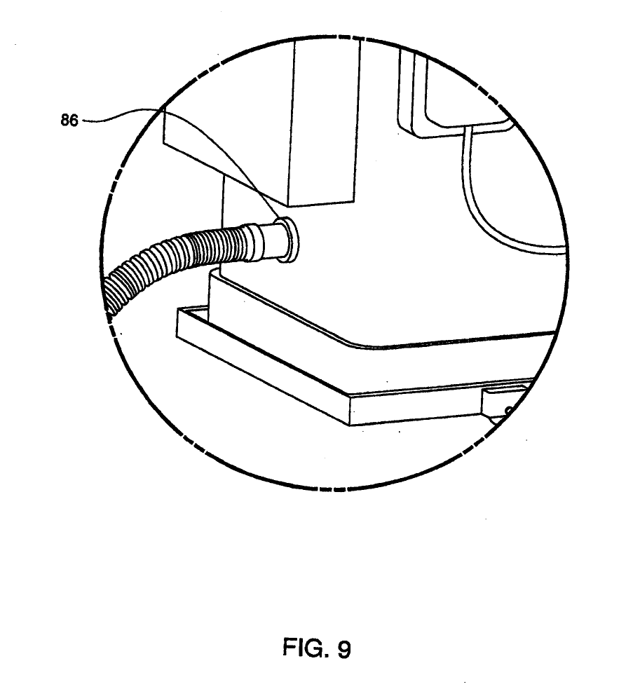

Blade enclosures of the present invention incorporate one or more of several aspects of the present invention disclosed in detail herein, and shown including: a blade enclosure 50 (FIG. 3), a removable blade cover 51, a blade enclosure vacuum seal 52 (FIG. 5), a seal 56 between the blade enclosure and the front cover, a front cover arbor vacuum seal 83 (FIG. 3), a blade enclosure mounting bracket 39 (FIGS. 1 and 2), which replaces the manufacturer's supplied splitter mounting bracket and splitter mounting bolt in this exemplary embodiment of the invention. Also incorporated in this invention are blade enclosure bracket mounting bolts 58 FIG. 2, a blade enclosure mounting screw 87 (FIG. 2), a secondary saw table insert which functions as a gasket 54 (FIGS. 6,7), and flexible hose connector 86 (FIG. 9) to a dust containment and collection system. A blade enclosure of the present invention, when designed to be retrofitted to an existing table saw, must be designed to fit the below the table structure and design of that particular saw. The exemplary blade enclosure, of FIGS. 1 through 5, is designed and adapted to be mounted on many models of existing Delta UNISAW® table saws which have been widely used throughout the world for over fifty years. It will be readily appreciated that one of ordinary skill, provided the disclosures herein, would readily be able to design and manufacture a suitable blade enclosure for many other models of table saws.

Table saws are designed to permit the saw blade, saw arbor 60 and saw motor carriage 61 (FIG. 1), to be adjustably titled at angles of up to 45 degrees relative to the normal upright or vertical saw blade position. This permits the saw operator to make bevel cuts of up to 45 degrees. The blade enclosure 50 (FIG. 1) must, therefore, be shaped and mounted to accommodate such adjustable tilting of the saw blade, saw arbor 60 and to permit saw motor carriage 61 to be adjustably titled at angles of up to 45 degrees without interference or obstruction between blade enclosure 50 or blade cover 51 and the underside of saw table 62 or the underside of saw table insert 57.

It will be appreciated that one of ordinary skill in the design, manufacture or operation of table saws would, if given the disclosures herein, understand that there are many ways in which blade enclosure 50 and front cover 51 could be so shaped and mounted. One of ordinary skill in the design, manufacture or operation of table saws, provided the disclosures herein, would readily be able to design and manufacture a suitable mount for a blade enclosure for any model of table saw. Exemplary rear mounting bracket 39 is mounted to saw motor carriage 61 using bolts 58, as shown in FIG. 2.

Blade enclosure 50 is then mounted to rear mounting bracket 39, which is threaded, using bolt 87 FIG. 2. Blade enclosure 50 is also mounted to that portion of saw motor carriage 61 adjacent to the front of the saw using bolt 59 FIG. 5. Bolt 59 fits, and is bolted into, an existing threaded bolt hole in saw motor carriage 61. Said threaded bolt hole is used in many models of table saw, including many models of Delta UNISAW® table saws, to support a saw dust chip deflector, which saw dust chip deflector is entirely replaced by blade enclosure 50 in the present invention. When the saw motor is tilted, to permit bevel cutting, the blade enclosure will thus also be equally tilted.

The blade cover 51 (FIG. 3) must be carefully designed to permit the enclosed saw blade to be tilted through the full range permitted by design of the saw, without being impeded by, or interfering with, any part or feature of the saw interior when the secondary table insert gasket is removed. This can be accomplished by careful attention to design of the geometry, shape and dimensions of the blade cover 51. As previously indicated, the exemplary blade cover 51 is designed to retrofit a blade enclosure of the present invention on a Delta UNISAW® table saw. Blade cover 51 is mounted to rear blade enclosure 50 with thumbscrews 81 (FIGS. 3 and 5) that may be hand tightened and easily removed for changing saw blades. It will be appreciated that one of ordinary skill in the design, manufacture or operation of table saws, if given the disclosures herein, would readily be able to design and manufacture a suitable mount for a blade enclosure for any model of table saw. For complete table saw of the present invention, the blade enclosure cover and the saw interior can be designed together as a system, to permit tilting of the saw blade.

The blade enclosure 50 and blade cover 51 may be made of any suitable material. Preferably, the enclosure should be primarily fabricated of a durable yet economical material such as steel, fiberglass, graphite, fiber composite or thermoplastic.

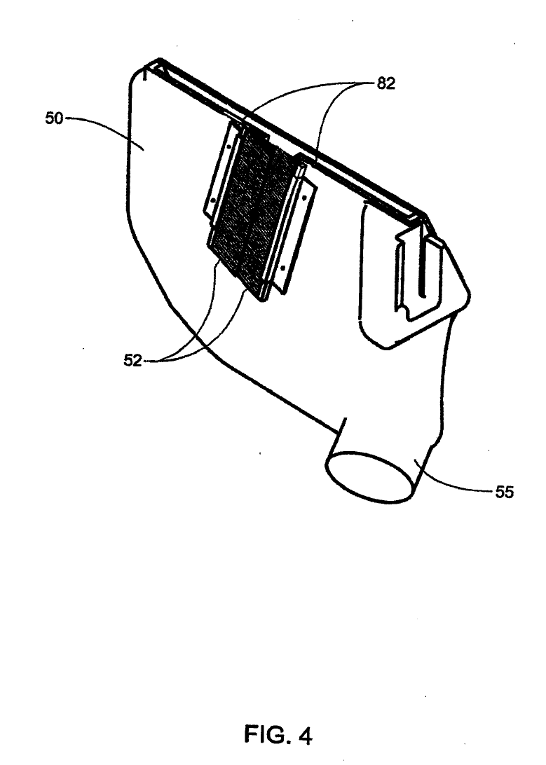

Table saws must permit the saw blade and saw arbor 60 (FIG. 1) to be adjusted vertically, relative to the saw motor carriage 61, and also to the saw table 62, to permit the saw to cut work pieces of different thicknesses. The blade enclosure 50 must therefore permit the saw arbor to pass through the blade enclosure at all vertical positions from the centerline of the blade enclosure at the lowest blade position to its uppermost margin. It will be appreciated that one of ordinary skill in the design, manufacture or operation of table saws would, if given the disclosures herein, understand that there are a number of methods in which the blade enclosure 50, and arbor seals, 52 (FIG. 4) could permit such vertical movement of the saw arbor. An exemplary blade enclosure according to the present invention accommodates vertical adjustment of the arbor by means of a curved slot 84 (FIG. 5), sealed with one or more replaceable strip brush seals 52, mounted to the body of the blade enclosure 50 by mounting channels 82 as shown in FIGS. 4 and 5.

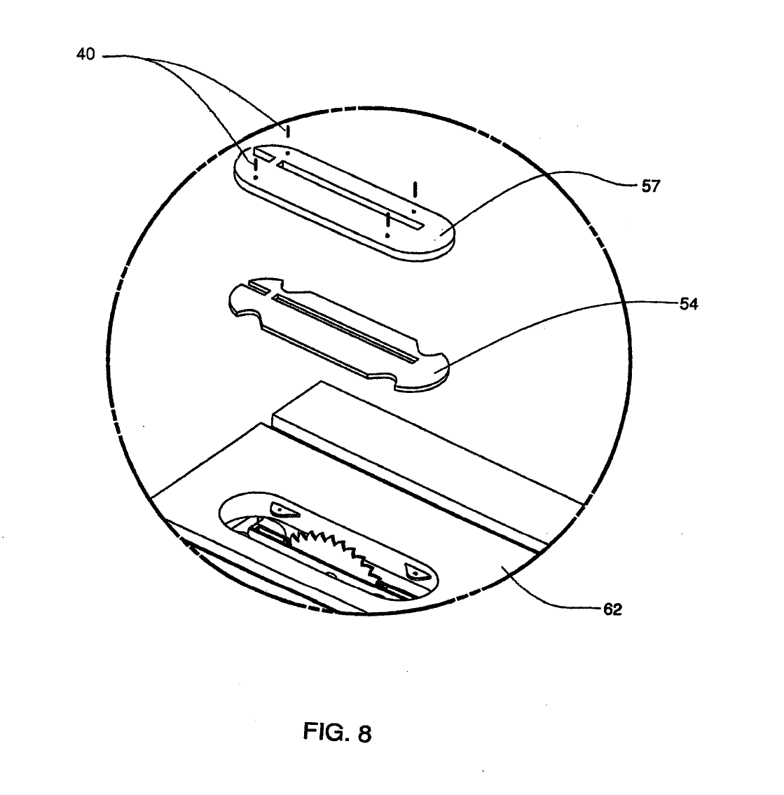

The dust control and collection features of blade enclosures of the present invention are achieved by connection of the blade enclosure 50 to a vacuum dust control and collection system with a 2.00″-2.25″ (50 mm-57 mm) inner diameter (ID) flexible hose and capable of maintaining an nominal air velocity of 1500-2000 feet per minute (760-1014 centimeters per second) at the table insert throat plate 57 (FIG. 8), level with the table surface. Exemplary blade enclosure 50 is thus provided with an exhaust port 55 (FIGS. 3, 4, 5). Preferably, one chooses a ratio, between a cross-sectional area of the longitudinal slot in table insert 57, and a cross-sectional area of outlet port 55 which is suitable to facilitate a desirably high airflow rate for entraining the saw dust particles and particulates.

It will be readily appreciated that one of ordinary skill, if given the disclosures herein, would readily be able to design and manufacture a suitable dust collection system connection port. Effective functioning of the dust containment and collection aspects of the blade enclosure requires that the blade enclosure 50 and blade cover 51 be carefully designed and constructed, so as to form a system capable of being sufficiently sealed from air leakage and to maintain sufficient vacuum integrity, in order to substantially prevent saw dust leakage into the saw interior or into the air surrounding the saw. The external vacuum or negative air flow employed must be sufficient to contain substantially all the dust produced by the saw within the blade enclosure, and to move such dust out of the blade enclosure and to the dust collection system at approximately the same rate at which dust is produced by the sawing blade. It will be appreciated that one of ordinary skill in the design, manufacture or operation of table saws, if given the disclosures herein, would readily be able to design and manufacture suitable seals for the blade enclosure to maintain a vacuum sufficient to accomplish effective dust containment and removal. The exemplary blade enclosure 50 and cover 51 are provided with a gasket seal 56 (FIG. 5), attached to the blade enclosure 50 that provides a seal between the blade cover 51 and blade enclosure. This gasket seal 56 may be made of any suitable material including rubber, cork, felt, synthetic fabric, polymers or composites.

The exemplary preferred blade enclosure 50 is provided with a replaceable brush seal 83 (FIG. 3), attached to the blade enclosure 50 to provide a seal over the arbor cutout 85 (FIG. 5) and provides a seal between the blade enclosure 50 and the saw blade arbor 60 (FIG. 1). As the height of the saw blade is adjusted upward, the rapidly rotating and vertically adjustable saw arbor 60 (FIG. 1) will partially project through the front cover cutout 85 (FIG. 5) at the upper range of blade height adjustment.

Replaceable brush seal 83 (FIG. 3) is intended to help maintain the strength of vacuum air flow within the enclosure 50, and to minimize saw dust leakage through cutout 85 when the saw is operating in the upper range of blade height adjustment, causing the saw blade arbor to project slightly through the front cover cutout 85 (FIG. 5).

It will be appreciated that one of ordinary skill in the design, manufacture or operation of table saws, if given the disclosures herein, would readily be able to design and manufacture suitable seals for the blade enclosure/saw arbor interface, of many configurations and designs and to manufacture such seals from many suitable materials or combinations of materials.

Replaceable seals 83 (FIG. 3) and 52 (FIGS. 4-5) may be made of any suitable material, including one or more fiber brushes, expanded foam, rubber, cork, felt, synthetic fabric, polymers or composites that will both provide an adequate seal and that will accommodate rotating saw arbor and that will further accommodate vertical adjustment of the saw arbor 60 (FIG.), relative to the saw motor carriage 61. Brush seals 83 (FIG. 3) and 52 (FIGS. 4-5) provide the required seal while accommodating saw arbor 60 (FIG. 1) rotational and height adjustment movement, in the exemplary embodiment shown.

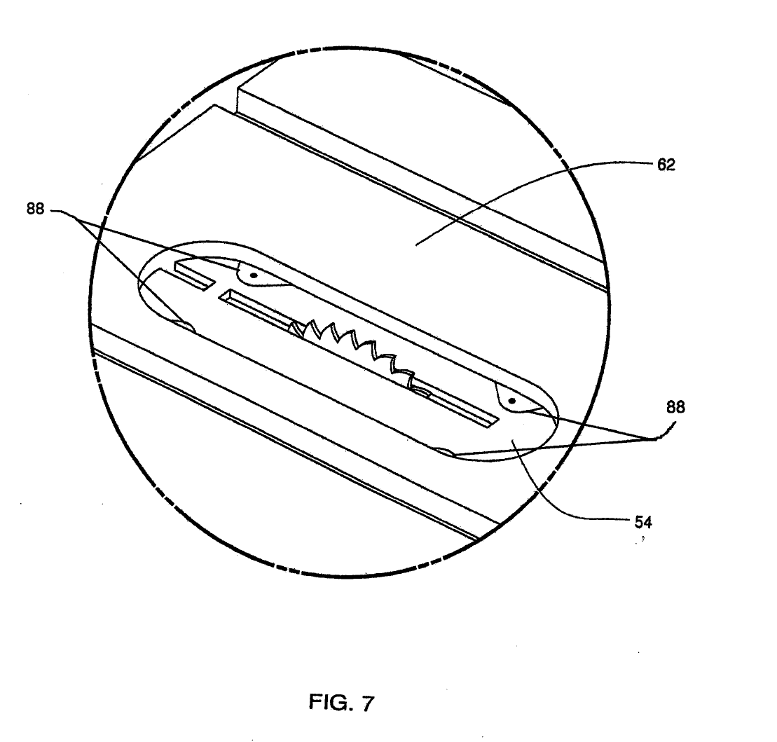

Vacuum integrity within the blade enclosure, and thus effectiveness of the dust control and collection system, can be further improved in table saws of the present invention by provision of a secondary insert gasket 54 (FIGS. 6-7), which provides a seal between saw table 62 (FIG. 7) and the upper edge of blade enclosure 50 and of blade cover 51, as shown in FIG. 8. Table saws are typically provided with a port, in the saw table 62, that is substantially larger than needed to accommodate the saw blade. In addition, table saws are typically provided with a replaceable table insert 57 (FIG. 8) which closely fits into the table port and which closely surrounds different sized blades or cutters, as they project up through the top of the saw table 62. When these standard inserts are in place, there remains a considerable space between the bottom surface of the insert and the upper edge of blade enclosure 50 and blade cover 51. A secondary table insert 54 (FIGS. 6,7,8) is employed in the present invention to fill the space between the upper edge of blade enclosure 50 and blade cover 51 and the bottom surface of standard saw table insert 57 which provides an improved vacuum seal for the blade enclosure 50 and blade cover 51.

Standard table inserts such as 57 (FIG. 8), are provided with four leveling set screws 40 (FIG. 8), which normally bear against the four insert support tabs 88 (FIG. 7), which are cast into the saw table top 62 (FIGS. 7-8), and are used to precisely adjust the top surface level of the table insert to match the surface level of the saw table. In the present embodiment, to compress table insert gasket 54 (FIG. 8), against the blade enclosure 50 (FIG. 3), and the blade enclosure cover 51 (FIG. 3), the four insert support tabs have been threaded to accommodate longer set screws intended to hold the table insert 57 level and firmly in place, and to compress the table insert gasket 54 against the blade enclosure.

Saw table insert gasket 54, may be made of any suitable compressible gasket material including foam board, PVC foam board, polypropylene, plastic, foam rubber, foam core, or any functionally suitable and cost effective material. Saw table insert 54 should be constructed of a material that will be easily and safely cut by the saw blade, such that no hazard will be posed to the saw operator, in the event of any accidental contact between the table insert gasket 54, with the saw blade. It will be appreciated that one of ordinary skill in the design, manufacture or operation of table saws, if given the disclosures herein, would readily be able to design and manufacture suitable table saw insert gaskets of many configurations and designs, and to manufacture such seals from many suitable materials or combinations of materials.

A flexible hose, connecting the blade enclosure to a vacuum or dust collection system, may be connected to blade enclosure port 55 and may exit the table saw at any convenient location. In a preferred embodiment, a convenient flexible hose fitting 86 (FIG. 9) is provided and attached to the base of the table saw. A length of flexible hose is connected to blade enclosure port 55, is run through the base cabinet of the table saw, and is connected to flexible hose fitting 86 inside the saw cabinet. The external side of flexible hose fitting 86 may then be connected by a length of flexible hose to a dust collector or a suitable source of vacuum. It will be appreciated that one of ordinary skill in the design, manufacture or operation of table saws would, if given the disclosures herein, understand that there are many ways in which the below-table blade enclosure of the present invention could be connected to a dust collection and containment system.

What is claimed is:

1. A particulate emission-minimization apparatus adapted for installation on a rotary sawing device having
a generally disc-shaped saw blade (20), mounted on
a saw arbor (60) supported by
a saw motor carriage (61) adjustably mounted below
a saw table (62) formed with a blade-receiving opening (89);
said particulate emission-minimization apparatus comprising
a motor carriage enclosure (50) adapted to be secured below said saw table (62) and having an upper periphery adapted to seal against said saw table, said enclosure being formed with an outlet port (55) adapted to be connected to a source of lower-than-ambient air pressure in order, during saw operation, to remove sawdust particles and particulates, of various sizes, from ambient air being breathed by a human saw operator;
a gasket seal (54) of flexible material formed with a longitudinal slot for receiving said saw blade (20), said gasket seal (54) being supported by said saw table (62), motor carriage enclosure 50, removable blade cover 51; and
a generally rigid table insert (57), dimensioned for placement in said blade-receiving opening (89) of said saw table, and formed with a longitudinal slot, said insert (57) being adapted for placement above said gasket seal in generally parallel relationship thereto.

2. The apparatus of claim 1, wherein
said motor carriage enclosure has two generally planar sidewalls angled with respect to each other, said sidewalls converging adjacent said saw blade receiving opening (89) in said saw table (62), and a combination bottom and end wall, formed with said outlet port (55).

3. The apparatus of claim 2, wherein said planar sidewalls subtend an angle with respect to each other sufficiently large to permit pivotal adjustment of said motor carriage and saw blade by at least 45 degrees, for purposes of making bevel cuts with said blade.

4. The apparatus of claim 1, wherein
a ratio between the cross-sectional area of said longitudinal slot in said table insert (57) and the cross-sectional area of said outlet port (55) is chosen to facilitate a desirably high airflow rate for entraining said sawdust particles and particulates.

5. The apparatus of claim 4, wherein said source of less-than-ambient air pressure is sufficiently powerful to maintain an airflow rate of at least 760 centimeters per second.

6. The apparatus of claim 1, further comprising
a bracket (39) adapted to support said motor carriage enclosure and to be supported in turn by said sawing device.

7. The apparatus of claim 6, wherein
said bracket (39) is formed with a plurality of holes, and
respective bolts (58, 87) secure said bracket to said enclosure and to said sawing device.

8. The apparatus of claim 1, wherein
said enclosure is formed with a resealable access opening to facilitate repositioning of said motor carriage while said sawing device is not being operated.

9. The apparatus of claim 1, wherein
a sidewall of said enclosure is formed with an opening to permit protrusion therethrough of an end of said motor arbor (60) when the latter is raised in height with respect to said saw table, and
a plurality of arbor sealing elements (52) are provided to minimize air leakage when said arbor protrudes through said opening.

10. The apparatus of claim 1, further comprising a vacuum source capable of generating suction lower than ambient air pressure, at said outlet port (55) of said enclosure.

11. The apparatus of claim 10, further comprising a flexible hose having an internal diameter of at least 50 mm for interconnecting said outlet port (55) and said vacuum source.

12. The apparatus of claim 1, further comprising
a blade cover (51) formed with an elongated opening (85) to permit adjustment of said saw arbor (60) within a range of positions.
